(19) United States
(12) Patent Application Publication
(10) Pub. No.: US 2016/0257296 A1
(43) Pub. Date: Sep. 8, 2016

(54) CONTROLLER FOR HYBRID VEHICLE

(71) Applicant: TOYOTA JIDOSHA KABUSHIKI KAISHA, Toyota-shi, Aichi-ken (JP)

(72) Inventors: Keita FUKUI, Fujinomiya-shi (JP); Hidekazu NAWATA, Gotemba-shi (JP); Toshio INOUE, Gotemba-shi (JP); Shunsuke FUSHIKI, Susono-shi (JP); Tomoaki HONDA, Gotemba-shi (JP); Yuta NIWA, Mishima-shi (JP); Taichi OSAWA, Susono-shi (JP)

(73) Assignee: TOYOTA JIDOSHA KABUSHIKI KAISHA, Toyota-shi, Aichi-ken (JP)

(21) Appl. No.: 15/029,087

(22) PCT Filed: Oct. 14, 2014
(86) PCT No.: PCT/IB2014/002091

§ 371 Date: Apr. 13, 2016

(30) Foreign Application Priority Data
Oct. 16, 2013 (JP) 2013-215384

(51) Int. Cl. B60W 20/13; B60L 11/14; B60L 11/18; B60L 1/00

(52) U.S. Cl. CPC B60W 20/13; B60L 1/006; B60L 11/14; B60L 11/1859; B60L 11/1861; Y10S 903/907

(57) ABSTRACT

A controller for a hybrid vehicle is a controller used for a hybrid vehicle that is equipped with an internal combustion engine, a rotating electric machine, and an electric storage device, and that is capable of an external power supply. The controller includes a required-power information obtaining section that obtains required power, and a control section that controls the hybrid vehicle so as to cause the internal combustion engine to drive the rotating electric machine in order to supply power generated by the rotating electric machine to the outside of the hybrid vehicle without charging the electric storage device, when the required power is greater than predetermined power.

### CROSS-REFERENCE TO RELATED APPLICATIONS

This application is a national phase application of International Application No. PCT/IB2014/002091, filed Oct. 14, 2014, and claims the priority of Japanese Application No. 2013-215384, filed Oct. 16, 2013, the content of both of which is incorporated herein by reference.

### BACKGROUND OF THE INVENTION

1. Field of the Invention

The present invention relates to a controller for a hybrid vehicle.

2. Description of Related Art

Conventionally, a hybrid vehicle that runs using an internal combustion engine and an electric motor is in practical use. The hybrid vehicle is equipped with a rotating electric machine and an electric storage device. The electric storage device can be charged with power generated by the rotating electric machine driven by the internal combustion engine.

Recently, some electric storage devices are charged by inserting a plug of a charging cable into a power source provided in a house and the like. Power of the electric storage device is sometimes discharged to the house (see Japanese Patent Application Publication No. 2007-236023 (JP 2007-236023 A), for example). The hybrid vehicle, in which power transfer is performed between the hybrid vehicle and the house through the charging cable as described above, is also referred to as “plug-in hybrid vehicle” (see Japanese Patent Application Publication No. 2013-51772 (JP 2013-51772 A, for example).

JP 2013-51772 A proposes a supply of power generated by a rotating electric machine mounted on the hybrid vehicle or a supply of power of an electric storage device mounted on the hybrid vehicle to the outside of the hybrid vehicle (hereinafter, sometimes referred to as “external power supply”).

In the external power supply, power, which has been generated by the rotating electric machine and then charged into the electric storage device, can also be used. A loss of the power described above (an energy loss) occurs due to power conversion between the internal combustion engine and the electric storage device.

### SUMMARY OF THE INVENTION

The present invention provides a controller for a hybrid vehicle, which makes it possible to reduce an energy loss, caused due to power conversion between an internal combustion engine and an electric storage device, when an external power supply is performed.

One aspect of the present invention is directed to a controller used for a hybrid vehicle that is equipped with an internal combustion engine, a rotating electric machine, and an electric storage device, and that is configured to supply electric power to an outside of the hybrid vehicle. The controller includes a required-power information obtaining section (an ECU) that obtains information regarding required power when an electric power supply to the outside of the hybrid vehicle is required, and a control section (the ECU) that controls the hybrid vehicle such that the internal combustion engine drives the rotating electric machine to supply power generated by the rotating electric machine to the outside of the hybrid vehicle without charging the electric storage device, when the required power is greater than predetermined power.

With this configuration, there is a case in which an electric power supply to the outside of the vehicle is performed without charging the electric storage device. In that case, an energy loss due to power conversion between the internal combustion engine and the electric storage device does not occur.

The control section may control the hybrid vehicle such that power of the electric storage device is supplied to the outside of the hybrid vehicle when the required power is equal to or lower than the predetermined power and a state of charge of the electric storage device is greater than a predetermined value, and the control section may control the hybrid vehicle such that the internal combustion engine drives the rotating electric machine to supply power generated by the rotating electric machine to the outside of the hybrid vehicle when the state of charge of the electric storage device is equal to or lower than the predetermined value.

The control section may control the hybrid vehicle such that the internal combustion engine drives the rotating electric machine to supply power generated by the rotating electric machine to the outside of the hybrid vehicle while charging the electric storage device, when the required power is equal to or lower than the predetermined power and the state of charge of the electric storage device is equal to or lower than the predetermined value.

The predetermined power may be power in which when the predetermined power is generated by the internal combustion engine, power-generation efficiency of the internal combustion engine becomes lower than a predetermined value.

According to the one aspect of the present invention, when an external power supply is performed, it is possible to reduce an energy loss caused due to power conversion between the internal combustion engine and the electric storage device.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is an overall block diagram of a hybrid vehicle controlled by a controller according to one embodiment of the present invention;

FIG. 2 is a diagram for explaining the connection between the vehicle and an electric device outside the vehicle;

FIG. 3 is a diagram for explaining an example of an ECU in detail;

FIG. 4 is a flowchart for explaining the control to be executed at the time of starting a power supply from the vehicle to the electric device (an external power supply);

FIG. 5 is a flowchart for explaining the control to be executed during the power supply from the vehicle to the electric device (the external power supply); and

FIGS. 6A and 6B are a flowchart for explaining the processing to be executed when the SOC of an electric storage device is reduced.

### DETAILED DESCRIPTION OF EMBODIMENTS

One embodiment of the present invention is described below in detail with reference to the accompanying drawings. In the drawings, like or equivalent elements are designated with like numerals, and therefore descriptions thereof are not repeated.

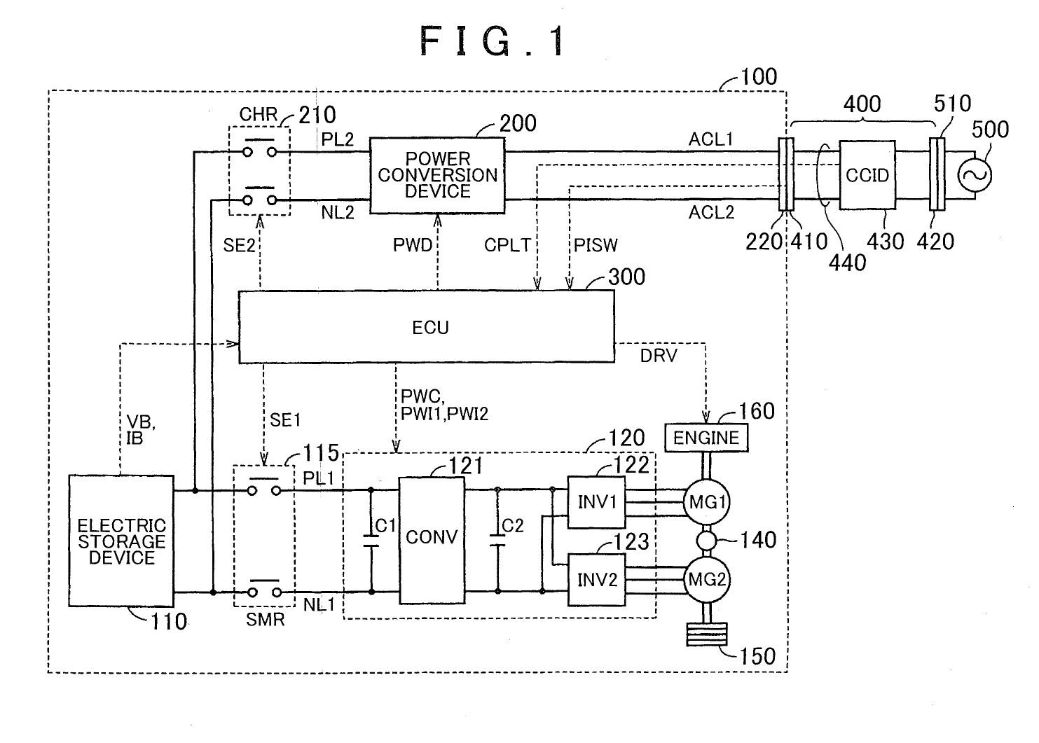

FIG. 1 is an overall block diagram of a hybrid vehicle 100 (hereinafter, simply referred to as “vehicle 100”) that is controlled by a controller for a hybrid vehicle according to the embodiment. With reference to FIG. 1, the vehicle 100 includes an electric storage device 110, a system main relay 115 (SMR 115), a power control unit (PCU) 120, motor generators MG1 and MG2, a power transmission gear 140, a drive wheel 150, an engine 160 that is an internal combustion engine, an electronic control unit (ECU) 300 that is the controller, a charging relay 210 (CHR 210), and a power conversion device 200. The PCU 120 includes a converter 121, inverters 122 and 123, and capacitors C1 and C2.

The electric storage device 110 is a power storing element that is configured to be chargeable and dischargeable. The electric storage device 110 is configured by including a secondary battery such as a lithium ion battery, a nickel hydrogen battery, or a lead-acid battery, or by including a power storing element such as an electric double-layer capacitor. The electric storage device 110 is connected to the PCU 120 through power lines PL1 and NL1. A voltage VB and a current IB of the electric storage device 110 are measured by a sensor (not shown), and information regarding the voltage VB and the current IB is transmitted to the ECU 300. The power lines PL1 and NL1 and power lines PL2 and NL2 are provided in parallel with the electric storage device 110. When the SMR 115 and the CHR 210 are in the on-state, the power lines PL1 and NL1 and the power lines PL2 and NL2 are energized and are at the same potential. The power lines PL1 and NL1 connect between the electric storage device 110 and the converter 121. The power lines PL2 and NL2 connect between the electric storage device 110 and the power conversion device 200. The electric storage device 110 can discharge power to the power lines PL1 and NL1 and to the power lines PL2 and NL2, and can also be charged through these power lines.

First, the configuration of the vehicle 100 from the electric storage device 110 to the power lines PL1 and NL1-side is explained below. The SMR 115 is provided between the electric storage device 110 and the power lines PL1 and NL1. The SMR 115 operates based on a control signal SE1 from the ECU 300. The SMR 115 electrically connects or disconnects between the electric storage device 110 and the PCU 120.

The PCU 120 includes the capacitor C1, the converter 121, the capacitor C2, and the inverters 122 and 123.

The converter 121 operates based on a control signal PWC from the ECU 300. The converter 121 performs voltage conversion. The capacitors C1 and C2 are connected to the converter 121 for smoothing and other purposes.

The inverters 122 and 123 are connected in parallel to the converter 121. The inverters 122 and 123 operate based on their respective control signals PWI1 and PWI2 from the ECU 300. The inverters 122 and 123 convert DC power supplied from the converter 121 to AC power, and supply the AC power to the motor generators MG1 and MG2, respectively. The inverters 122 and 123 can also convert power (AC power) generated by the motor generators MG1 and MG2 to DC power, and supply the DC power to the converter 121.

The motor generators MG1 and MG2 are AC rotating electric machines. An output torque from the motor generators MG1 and MG2 is transmitted to the drive wheel 150 through the power transmission gear 140. The power transmission gear 140 includes a reduction gear and a power split mechanism. At the time of regenerative breaking of the vehicle 100, the motor generators MG1 and MG2 can generate power using a rotational force of the drive wheel 150. The motor generators MG1 and MG2 are also coupled with the engine 160 through the power transmission gear 140. The motor generators MG1 and MG2 and the engine 160 operate in a coordinated manner under the control of the ECU 300. Thus, a vehicle driving force can be generated in response to a request. Not only at the time of regenerative braking of the vehicle 100, the motor generators MG1 and MG2 can also generate power using rotations of the engine 160.

With the above configuration, the ECU 300 can control the vehicle 100 so as to cause the engine 160 to drive the motor generators MG1 and MG2 in order to supply power generated by the motor generators MG1 and MG2 to the power lines PL1 and NL1.

Next, the configuration of the vehicle 100 from the electric storage device 110 to the power lines PL2 and NL2-side is explained below. The CHR 210 is provided between the electric storage device 110 and the power lines PL2 and NL2. The CHR 210 operates based on a control signal SE2 from the ECU 300. The CHR 210 electrically connects or disconnects between the electric storage device 110 and the power conversion device 200.

The power conversion device 200 is connected to an inlet 220 through power lines ACL1 and ACL2. The power conversion device 200 is controlled by a control signal PWD from the ECU 300. The power conversion device 200 converts power (basically AC power) from the inlet 220 to DC power, and supplies the DC power to the power lines PL2 and NL2. The power conversion device 200 can also convert DC power that is input from the power lines PL2 and NL2 to AC power, and supply the AC power to the power lines ACL1 and ACL2. The power conversion device 200 may be one device capable of power conversion in both directions for charging and supplying power, or may include separate devices for charging and for supplying power.

In an example shown in FIG. 1, a charging connector 410 of a charging cable 400 is connected to the inlet 220. Thus, power from an external power source 500 that is located outside the vehicle 100 is provided to the inlet 220. The charging cable 400 includes, in addition to the charging connector 410, a plug 420 that connects to an outlet 510 of the external power source 500, and a power line 440 that connects between the charging connector 410 and the plug 420. A charging circuit interrupt device (CCID) 430 that switches between a supply of power from the external power source 500 and an interrupt of the power supply is interposed in the power line 440.

With the above configuration, the ECU 300 can control the vehicle 100 so as to supply power of the power lines PL2 and NL2 to the outside of the vehicle 100.

The ECU 300 includes a central processing unit (CPU), a storage device, and an input-output buffer (all not shown). The ECU 300 has a signal input from each sensor and the like, and outputs a control signal to each device. The ECU 300 also controls the electric storage device 110 and each device in the vehicle 100. These controls can be achieved by dedicated hardware (such as an electronic circuit), or can also be achieved by software. The ECU 300 calculates a residual capacity SOC (state of charge) of the electric storage device 110 based on detection values of the voltage VB and the current 1B from the electric storage device 110. The ECU 300 receives a proximity detection signal PISW that indicates a connection state of the charging cable 400 from the charging connector 410. Further, the ECU 300 receives a control pilot signal CPLT from the CCID 430 of the charging cable 400. The ECU 300 performs a charging operation based on these signals. The signal PISW that indicates the connection state and the pilot signal CPLT are standardized by the Society of Automotive Engineers (SAE) in the US and the Japan Electric Vehicle Association, for example.

As explained above with reference to FIG. 1, by the control executed by the ECU 300, the vehicle 100 that is equipped with the electric storage device 110 and the engine 160 can (1) perform an external power supply using only power of the electric storage device 110 (an external power supply only from the electric storage device). Further, the vehicle 100 can (2) use only power generated by the motor generator MG1 driven by the engine 160 (an external power supply only from the engine). Furthermore, the vehicle 100 can (3) use a combination of the power of the electric storage device 110 and the power generated by the motor generator MG1 (an external power supply from both the electric storage device and the engine).

In the case of (1) the external power supply only from the electric storage device, the converter 121 does not supply power to the power lines PL1 and NL1. Meanwhile, the power conversion device 200 converts power that is input from the power lines PL2 and NL2, and supplies the converted power to the power lines ACL1 and ACL2. As a result, the electric storage device 110 discharges power to the power lines PL2 and NL2.

In contrast, in the case of (2) the external power supply only from the engine, the converter 121 supplies power to the power lines PL1 and NL1. The power conversion device 200 converts power that is input from the power lines PL2 and NL2, and supplies the converted power to the power lines ACL1 and ACL2. At this time, the converter 121 and the power conversion device 200 are controlled by the ECU 300 in order that the power supplied from the converter 121 to the power lines PL1 and NL1 is equal to the power that is input from the power lines PL2 and NL2 to the power conversion device 200. As a result, the electric storage device 110 does not discharge power to the power lines PL2 and NL2. Further, the electric storage device 110 is not charged through the power lines PL1 and NL1. Thus, a power loss associated with charge and discharge of the electric storage device 110, that is, for example, a loss (an energy loss), caused due to power conversion between the engine 160 and the electric storage device 110 for the purpose of charging the electric storage device 110, can be suppressed. Even under the control as described above, the electric storage device 110 is sometimes slightly charged or slightly discharges power. However, it should be understood that such microscopic charge and discharge is not included in the charge and discharge of the electric storage device 110 in the present embodiment. That is, the ECU 300 controls the vehicle 100 so as to cause the engine 160 to drive the motor generator MG1 in order to supply power generated by the motor generator MG1 to the outside of the vehicle 100 without charging the electric storage device 110.

Further, in the case of (3) the external power supply from both the electric storage device and the engine, the converter 121 supplies power to the power lines PL1 and NL1. The power conversion device 200 converts power that is input from the power lines PL2 and NL2, and supplies the converted power to the power lines ACL1 and ACL2. At this time, the power that is input from the power lines PL2 and NL2 to the power conversion device 200 is greater than the power supplied from the converter 121 to the power lines PL1 and NL1. As a result, the electric storage device 110 discharges power to the power lines PL2 and NL2.

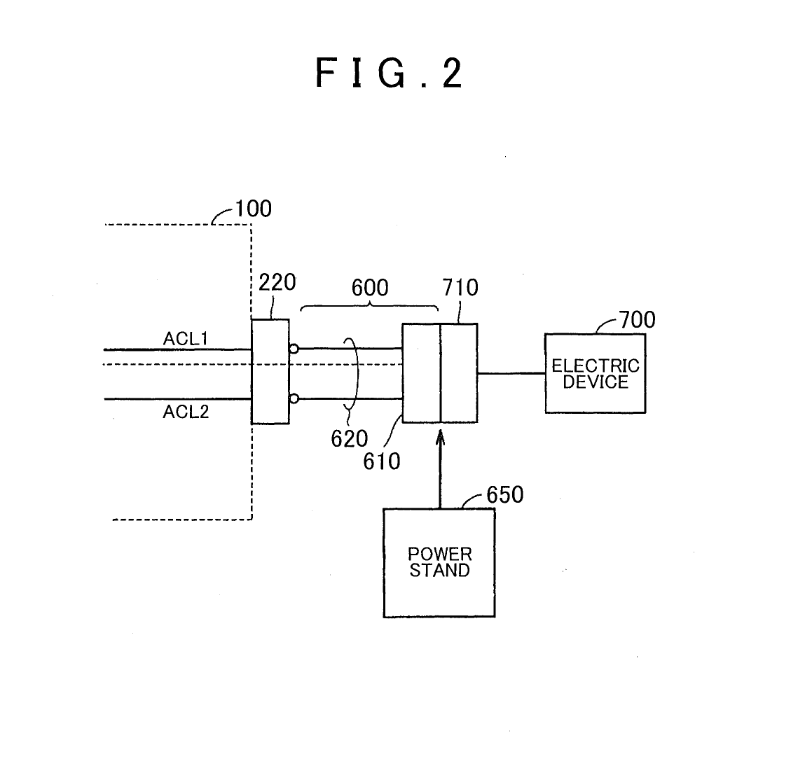

FIG. 2 is a diagram for explaining the connection between the vehicle 100 and an electric device outside the vehicle 100 during an external power supply. As shown in FIG. 2, when the vehicle 100 supplies power to an electric device 700, a connector dedicated to a power supply (a power-supply connector) 600 is used. In the power-supply connector 600, an output section 610 is provided, to which a power-source plug 710 of the electric device 700 outside the vehicle 100 can be connected. When the power-supply connector 600 is connected to the inlet 220, the power lines ACL1 and ACL2 located on the vehicle 100-side and the output section 610 are electrically connected through a power transmission section 620. The output section 610 of the power-supply connector 600, and the power-source plug 710 can also be connected through a power stand 650.

With reference to FIGS. 1 and 2, the ECU 300 is configured to recognize (or detect) the connection of the power-supply connector 600 to the inlet 220. For example, this recognition is performed using a switch (not shown) that operates in response to the connection of the power-supply connector 600 to the inlet 220. Further, the ECU 300 may be configured to communicate with the outside of the vehicle 100 through the power-supply connector 600. Signals such as the signal CPLT and the signal PISW described above may be used in the communication. Furthermore, power line communication (PLC) may be used. For example, when the power-supply connector 600 is connected to the inlet 220, the vehicle 100 is set to an operating state where an external power supply is ready (an external power-supply mode). Further, when the power supply connector 600 is removed from the inlet 220 for example, the vehicle 100 finishes the external power-supply mode.

When the vehicle 100 is set to the external power-supply mode, the ECU 300 brings the CHR 210 into the on-state, and also operates the power conversion device 200 to supply power from the vehicle 100 to the electric device 700. Thus, the external power supply is performed. During the external power supply, power from the electric storage device 110, power generated by the motor generator MG1 driven by the engine 160, or a combination of the former and latter power, is transmitted to the power conversion device 200. Upon receiving the power as described above, the power conversion device 200 converts this power to a voltage and a current (power) required for an appropriate operation of the electric device 700, and outputs the converted power. For example, the ECU 300 utilizes communication between the ECU 300 and the outside of the vehicle 100 to obtain information related to the voltage and the current required for an electric power supply to the electric device 700 (required power).

The power stand 650 can also be used for the communication between the ECU 300 and the outside of the vehicle 100. For example, the power stand 650 is provided between the output section 610 of the power-supply connector 600 and the power-source plug 710 of the electric device 700. The power stand 650 includes a switch (not shown) that operates in response to the connection of the power-supply connector 600 to the inlet 220, for example. Further, the power stand 650 can include a circuit configuration for generating a communication signal, and a communication interface, although they are not shown in FIG. 2. That is, the power stand 650 is configured to transmit information related to the power required for the operation of the electric device 700 (required power) to the vehicle 100, that is, for example, to the ECU 300.

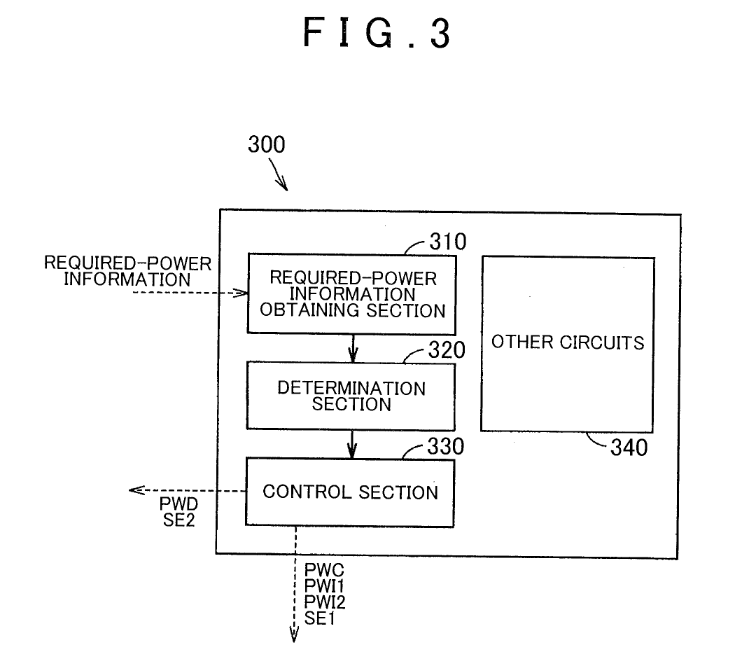

FIG. 3 is a diagram for explaining an example of the ECU 300 in FIG. 1 in detail. With reference to FIG. 3, the ECU 300 includes a required-power information obtaining section 310, a determination section 320, a control section 330, and other circuits 340.

With reference to FIGS. 1 to 3, when an electric power supply to the outside of the vehicle 100 is required, the required-power information obtaining section 310 obtains information related to required power (required-power information) transmitted through the power-supply connector 600, for example. The obtained required-power information is transmitted to the determination section 320.

Upon receiving the required-power information transmitted from the required-power information obtaining section 310, the determination section 320 determines whether the required power is greater than predetermined power. The predetermined power can be defined based on the efficiency of the engine 160 for the external power supply. Specifically, in the case in which the required power is met by (2) the external power supply only from the engine 160, then when the required power is greater than the predetermined power, the efficiency of the engine 160 is comparatively higher, and when the required power is equal to or lower than the predetermined power, the efficiency of the engine 160 is comparatively lower. That is, the predetermined power is power in which the engine 160 is operated at a lower-load operation point (operation state) for power required from the outside of the vehicle 100. A determination result of the determination section 320 is transmitted to the control section 330.

The control section 330 receives the determination result of the determination section 320, and controls an electric power supply from the vehicle 100 to the electric device 700. When the determination section 320 determines that the required power is greater than the predetermined power, the control section 330 gives a higher priority to (2) the external power supply only from the engine 160. When the power supply only from the engine is insufficient, the control section 330 can also perform (3) the external power supply from both the electric storage device 110 and the engine 160. In contrast to this, when the required power is equal to or lower than the predetermined power, the control section 330 selects an optimum external power supply among (1) the external power supply only from the electric storage device 110, (2) the external power supply only from the engine 160, and (3) the external power supply from both the electric storage device 110 and the engine 160. Whether any of the external power supplies (1) to (3) is performed can be decided in consideration of the SOC of the electric storage device 110.

The other circuits 340 include a circuit that constitutes the CPU, the storage device, the input-output buffer, and the like.

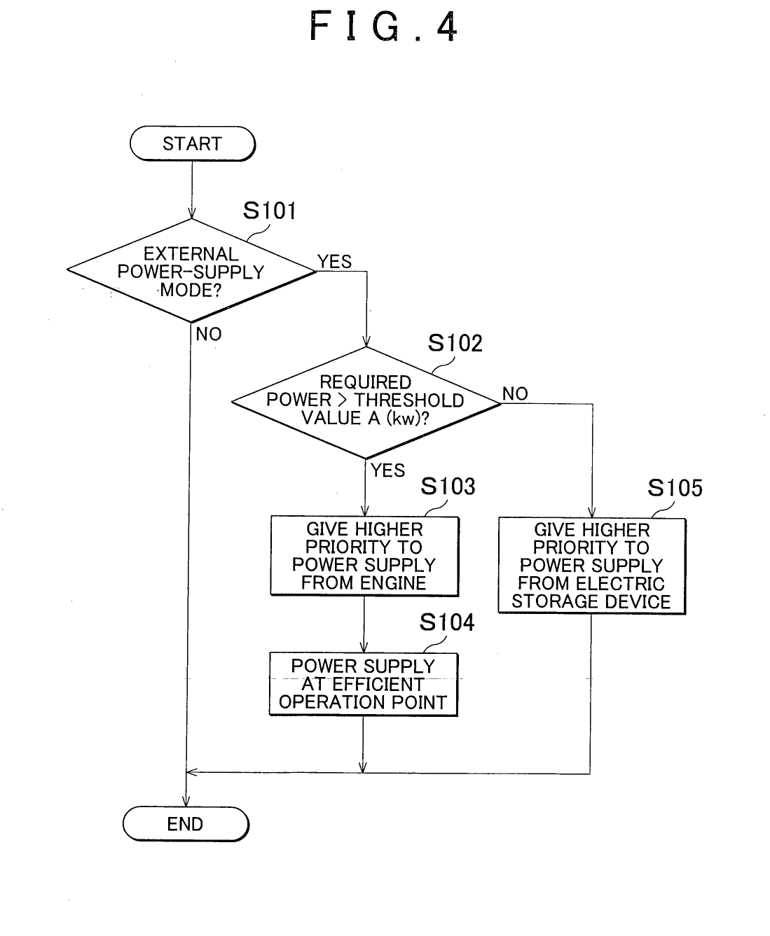

FIG. 4 is a flowchart for explaining the control to be executed at the time of starting a power supply from the vehicle 100 in FIGS. 1 and 2 to the electric device 700 (an external power supply). The processing in this flowchart is executed by the ECU 300 shown in FIG. 1 and the like.

With reference to FIGS. 1, 3, and 4, whether the vehicle 100 has been set to the external power-supply mode is first determined (step S101). When the vehicle 100 has been set to the external power-supply mode (YES in step S101), the processing is advanced to step S102. In contrast, when the vehicle 100 has not been set to the external power-supply mode (NO in step S101), the flowchart terminates.

In step S102, whether required power is greater than a threshold value A is determined. When the required power is greater than the threshold value A (YES in step S102), the processing is advanced to step S103. In contrast, when the required power is equal to or lower than the threshold value A (NO in step S102), the processing is advanced to step S105. In the power generation at the threshold value A, the engine 160 is operated at a low-load (light-load) operation point, and thus the power-generation efficiency of the MG1 driven by the engine 160 is defined as a predetermined value. That is, in the power generation at the threshold value A or lower, the power-generation efficiency becomes lower than the predetermined value.

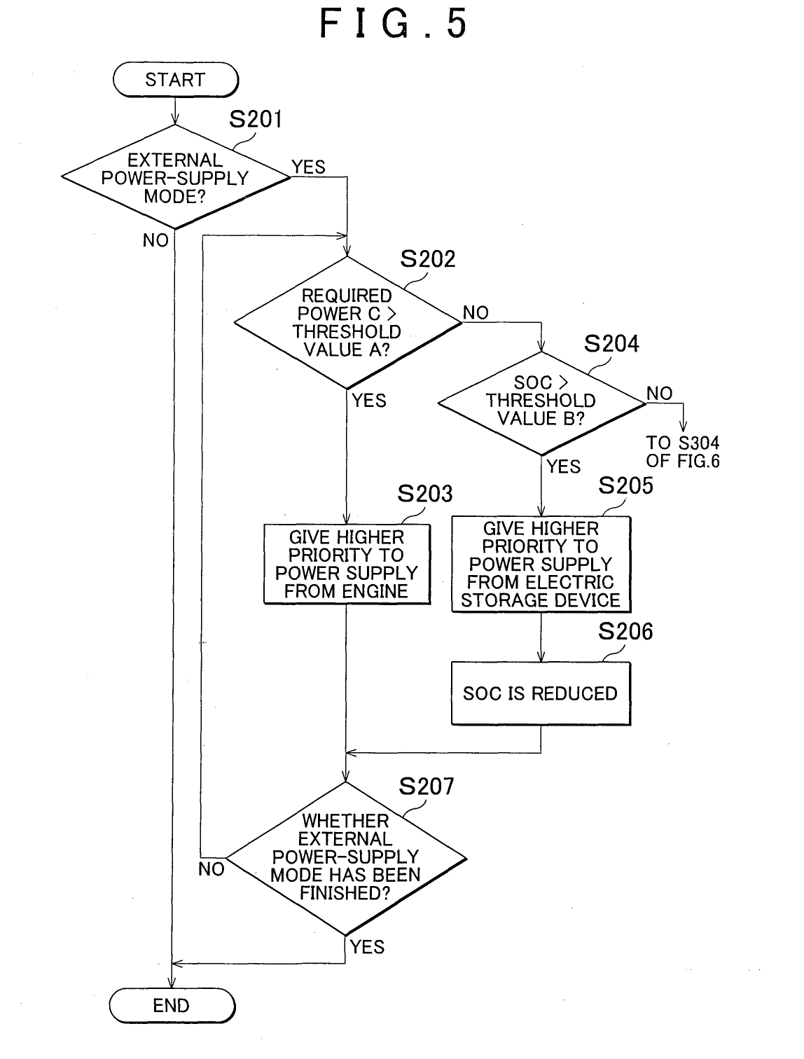

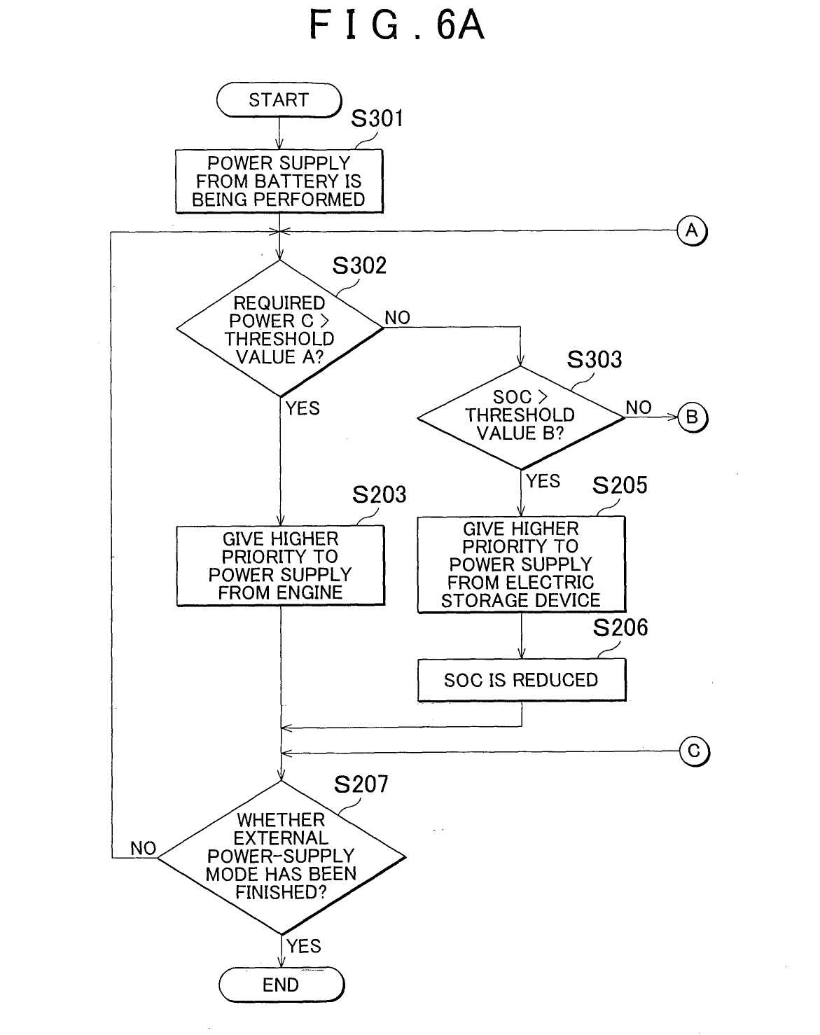

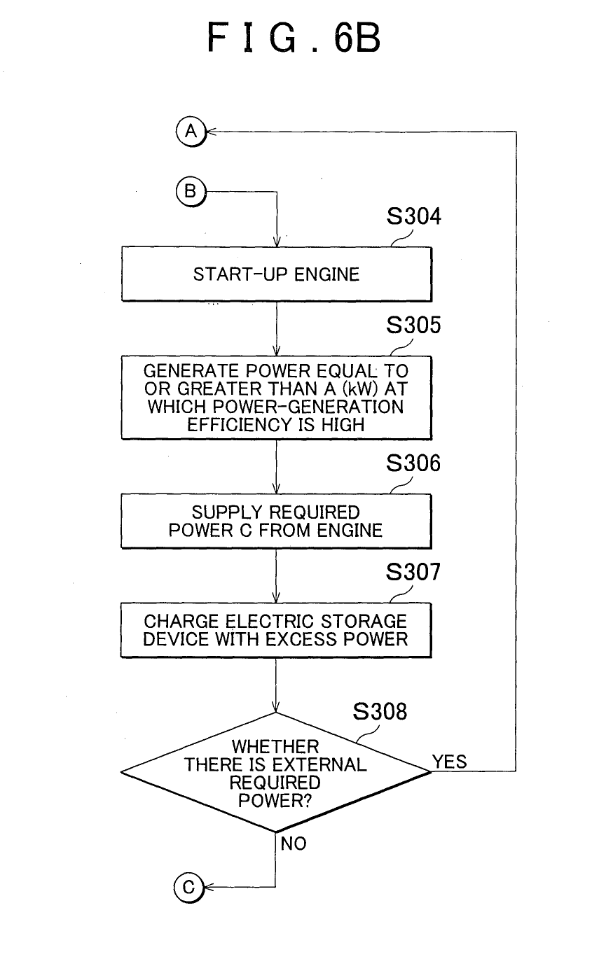

In step S103, a higher priority is given to (2) the external power supply only from the engine 160. In this case, because the electric storage device 110 is not charged, an energy loss due to power conversion between the engine 160 and the electric storage device 110 does not occur. Further, because power greater than the threshold value A is generated, the engine 160 is operated in an efficient state (at an efficient operation point) (Step S104). After the external power supply is started in the manner as described above, the processing in the flowchart is finished. In step S103, the engine 160 can be operated at an optimum-efficiency operation point. This is explained later with reference to FIGS. 6A and 6B.

Meanwhile, in step S105, a higher priority is given to (1) the external power supply only from the electric storage device 110. After the external power supply is started in the manner as described above, the processing in the flowchart is finished. Whether the processing in step S105 is executed may be determined in consideration of the SOC of the electric storage device 110. This is next explained with reference to FIG. 5.

FIG. 5 is a flowchart for explaining the control to be executed during a power supply from the vehicle 100 in FIGS. 1 and 2 to the electric device 700 (an external power supply).

With reference to FIGS. 1, 3, and 5, whether the vehicle 100 has been set to the external power-supply mode is first determined (step S201). When the vehicle 100 has been set to the external power-supply mode (YES in step S201), the processing is advanced to step S202. In contrast, when the vehicle 100 has not been set to the external power-supply mode (NO in step S201), the flowchart terminates.

In step S202, whether required power C (kW) is greater than the threshold value A is determined. When the required power C is greater than the threshold value A (YES in step S202), the processing is advanced to step S203. In contrast, when the required power C is equal to or lower than the threshold value A (NO in step S202), the processing is advanced to step S204.

In step S203, a higher priority is given to (2) the external power supply only from the engine 160. After the external power supply is started in the manner as described above, the processing is advanced to step S207.

Meanwhile, in step S204, whether the SOC of the electric storage device 110 is greater than a threshold value B is determined. When the SOC of the electric storage device 110 is greater than the threshold value B (YES in step S204), the processing is advanced to step S205. In contrast, when the SOC is equal to or lower than the threshold value B (NO in step S204), the processing is advanced to step S304 in FIGS. 6A and 6B, which is described later. The threshold value B is a preferable residual capacity (%) to be maintained for the vehicle 100 for its hybrid driving, for example.

In step S205, a higher priority is given to (1) the external power supply only from the electric storage device 110. Thus, the SOC of the electric storage device 110 is reduced (step S206). After the external power supply is started in the manner as described above, the processing is advanced to step S207.

In step S207, whether the vehicle 100 has finished the external power-supply mode is determined. When the vehicle 100 has finished the external power-supply mode (YES in step S207), the flowchart terminates. In contrast, when the vehicle 100 has not yet finished the external power-supply mode (NO in step S207), the processing is returned to step S202 again.

FIGS. 6A and 6B are a flowchart for explaining the processing to be executed when the external power supply from the electric storage device 110 is performed, and thus the SOC of the electric storage device 110 is reduced (for example, NO in step S204 in FIG. 5).

With reference to FIGS. 1, 3, 6A, and 6B, the vehicle 100 is first performing the external power supply from the electric storage device 110 (step S301). Next, whether the required power C is greater than the threshold value A is determined (step S302). This processing in step S302 is the same as the processing in step S202 in FIG. 5. In step S302, when the required power C is greater than the threshold value A (YES in step S302), the processing that is the same as the processing in step S203 and its following step in FIG. 5 is performed. In contrast, when the required power C is equal to or lower than the threshold value A (NO in step S302), the processing is advanced to step S303.

In step S303, whether the SOC of the electric storage device 110 is greater than the threshold value B is determined. This processing in step S303 is the same as the processing in step S204 in FIG. 5. In step S303, when the SOC of the electric storage device 110 is greater than the threshold value B (YES in step S303), the processing that is the same as the processing in step S205 and its following steps in FIG. 5 is performed. In contrast, when the SOC of the electric storage device 110 is equal to or lower than the threshold value B (NO in step S303), the processing is advanced to step S304.

In step S304, the engine 160 is started-up. Thereafter, the engine 160 drives the motor generator MG1 so as to generate power equal to or greater than the threshold value A in an efficient state. The efficient state refers to a state where the efficiency of the engine 160 is high, and the power-generation efficiency of the motor generator MG1 is high. Thus, the externally-supplied power (the required power C) is supplied only from the engine 160 (step S306). At this time, the difference (excess power) between power (equal to greater than A) generated by the engine 160 and the required power C is charged into the electric storage device 110 (step S307). In the state where the external power supply from the engine 160 has been performed and the electric storage device 110 has been charged as described above, the processing is advanced to step S308.

In step S308, whether there is required power is determined. When there is not required power (NO in step S308), the processing is advanced to step S207. In contrast, when there is the required power (YES in step S308), the processing is returned to step S302.

Therefore, when the external power supply is performed, it is possible to operate the engine 160 at an operation point, at which the power-generation efficiency is comparatively higher, based on the required power and the SOC of the electric storage device 110.

Lastly, the embodiment of the present invention is summarized With reference to FIGS. 1 to 3, the controller (the ECU 300) for a hybrid vehicle according to the embodiment is a controller (the ECU 300) used for the hybrid vehicle 100 that is equipped with the internal combustion engine (the engine 160), the rotating electric machines (the motor generators MG1 and MG2), and the electric storage device 110, and that is capable of an external power supply. The controller (the ECU 300) includes the required-power information obtaining section 310 that obtains required power when an electric power supply to the outside of a vehicle is required, and the control section 330 that controls the hybrid vehicle 100 so as to cause the internal combustion engine (the engine 160) to drive the rotating electric machines (the motor generators MG1 and MG2) in order to supply power generated by the rotating electric machines (the motor generators MG1 and MG2) to the outside of the hybrid vehicle 100 without charging the electric storage device 110, when the required power is greater than predetermined power (A).

Preferably, as shown in FIG. 5 and the like, the control section 330 controls the hybrid vehicle 100 so as to supply power of the electric storage device 110 to the outside of the hybrid vehicle 100 when the required power (C) is equal to or lower than the predetermined power (A), and also when a residual capacity of the electric storage device 110 is greater than a predetermined capacity (B), and the control section 330 controls the hybrid vehicle 100 so as to cause the internal combustion engine (the engine 160) to drive the rotating electric machines (the motor generators MG1 and MG2) in order to supply power generated by the rotating electric machines (the motor generators MG1 and MG2) to the outside of the hybrid vehicle 100 when the residual capacity of the electric storage device 110 is equal to or lower than the predetermined capacity (B).

Preferably, the control section 330 causes the internal combustion engine (the engine 160) to drive the rotating electric machines (the motor generators MG1 and MG2) in order to supply power generated by the rotating electric machines (the motor generators MG1 and MG2) to the outside of the hybrid vehicle 100, while charging the electric storage device 110, when required power (C) obtained by the required-power information obtaining section 310 is equal to or lower than the predetermined power (A), and also when the residual capacity of the electric storage device 110 is equal to or lower than the predetermined capacity (B). The predetermined power (A) is power in which the power-generation efficiency of the rotating electric machines (the motor generators MG1 and MG2) driven by the internal combustion engine (the engine 160) becomes predetermined efficiency.

Preferably, the predetermined power is power in which the internal combustion engine is operated at a lower-load operation point for power required from the outside of the vehicle.

In the controller for a hybrid vehicle according to the embodiment, an energy loss, caused due to power conversion between the engine and the electric storage device, can be reduced. The energy loss can further be reduced by operating the engine at a high-efficiency operation point.

It should be understood that the embodiment disclosed herein is only exemplary in all aspects and not to be construed as restrictive in nature. The scope of the present invention is defined not by the descriptions of the above embodiment, but by the appended claims, and is intended to include all equivalents covered by the claims and all modifications that fall within the scope of the claims.

1. A controller for a hybrid vehicle, the hybrid vehicle including an internal combustion engine, a rotating electric machine, and an electric storage device, the hybrid vehicle being configured to supply electric power to an outside of the hybrid vehicle, the controller comprising
an electronic control unit configured to
(a) obtain information regarding required power when an electric power supply to the outside of the hybrid vehicle is required; and
(b) control the hybrid vehicle such that the internal combustion engine drives the rotating electric machine to supply power generated by the rotating electric machine to the outside of the hybrid vehicle without charging the electric storage device, when the required power is greater than predetermined power.

2. The controller according to claim 1, wherein the electronic control unit is configured to control the hybrid vehicle such that power of the electric storage device is supplied to the outside of the hybrid vehicle when the required power is equal to or lower than predetermined power and a state of charge of the electric storage device is greater than a predetermined value, and
the electronic control unit is configured to control the hybrid vehicle such that the internal combustion engine drives the rotating electric machine to supply power generated by the rotating electric machine to the outside of the hybrid vehicle when the state of charge of the electric storage device is equal to or lower than the predetermined value.

3. The controller according to claim 2, wherein the electronic control unit is configured to control the hybrid vehicle such that the internal combustion engine drives the rotating electric machine to supply power generated by the rotating electric machine to the outside of the hybrid vehicle while charging the electric storage device, when the required power is equal to or lower than predetermined power and the state of charge of the electric storage device is equal to or lower than the predetermined value.

4. The controller according to claim 1, wherein the predetermined power is power in which when the predetermined power is generated by the internal combustion engine, power-generation efficiency of the internal combustion engine becomes lower than a predetermined value.
